(19) United States
(12) Patent Application Publication
(10) Pub. No.: US 2007/0082089 A1
(43) Pub. Date: Apr. 12, 2007

(54) Vitamin containing pet food compositions

(76) Inventors: Stephanie Krammer, Lorrach-Hauingen (DE); Gilbert Weber, Magden (CH)

Correspondence Address: NIXON & VANDERHYE, PC, 901 NORTH GLEBE ROAD, 11TH FLOOR, ARLINGTON, VA, 22203, US

(21) Appl. No.: 10/572,097

(22) PCT Filed: Sep. 14, 2004
(86) PCT No.: PCT/EP04/10236

§ 371 Date: Mar. 16, 2006

(30) Foreign Application Priority Data
Sep. 22, 2003 (EP) 03021365.6

(51) Int. Cl. A23L 1/30

(52) U.S. Cl. 426/72

(57) ABSTRACT

Pet food comprising 25-hydroxycholecalciferol and, optionally, vitamin D3 may find use for treatment and prevention of joint diseases, especially osteochondrosis, degenerative arthritis or arthropathy in pets, especially large dogs.

The present invention relates to compositions comprising 25-hydroxycholecalciferol (25-hydroxy-vitamin D₃), and to the use of 25-hydroxycholecalciferol for preventing and treating joint diseases in pets.

More particularly, the present invention in a first aspect relates to a pet food, comprising 25-hydroxycholecalciferol in a concentration of from about 500 IU to about 5000 IU per kg food, particularly from about 500 IU to about 2000 IU per kg food. The invention further relates to the use of 25-hydroxycholecalciferol in the manufacture of a food or veterinary composition for treatment or prevention of joint diseases in pets. In a still further aspect, the invention relates to a method of treatment or prevention of osteochondrosis in pets which comprises administering to a pet in need of such treatment or prevention an effective amount of 25-hydroxycholecalciferol.

In yet another aspect, the present invention relates to a pet food, comprising 25-hydroxycholecalciferol in a concentration of from about 500 IU to about 5000 IU per kg food, particularly from about 500 IU to about 2000 IU per kg food and vitamin D₃ in a concentration of from about 500 IU to about 5000 IU per kg food, particularly from about 500 IU to about 2000 IU per kg food, the total amount of 25-hydroxycholecalciferol and vitamin D₃ not exceeding 5000 IU per kg food; as well as to the use of a combination of 25-hydroxycholecalciferol and vitamin D₃ in the manufacture of a food or veterinary composition for treatment or prevention of joint diseases in pets; and to a method of treatment or prevention of osteochondrosis in pets which comprises administering to a pet in need of such treatment or prevention an effective amount of 25-hydroxycholecalciferol and of vitamin D₃.

The term “IU” (International Unit) is used herein for both vitamin D₃ and 25-hydroxycholecalciferol, 1 IU corresponding to 0.025 microgram of vitamin D₃ and 25-hydroxycholecalciferol, respectively.

Examples of pets include dogs, cats and rodents, e.g., chinchillas, guinea pigs, degus, mice, gerbils, hamsters, rats, ferrets and lagomorphes, e.g., rabbits. Animals of all ages are included, e.g. young, adults, animals of medium age and seniors. The compositions and method of treatment are of primary interest for use in large (dogs over 25 kg BW, e.g. German Shepherd, Labrador Retriever, Golden Retriever, Boxer, Briard, Beauceron, Weimaraner) and giant breeds of dogs (dogs over 45 kg BW, e.g. Great Danes, Saint Bernards, Rottweiler, Leonberger, Newfoundland, Great Pyrenees). Osteochondrosis is a disturbance in endochondral ossification that is sometimes classified as dyschondroplasia. It may involve the separation of the immatur articular cartilage from the underlying epiphyseal bone, which sometimes dissects completely free and floats loose in the synovial cavity and results in accompanying synovitis, or it may result in the retention of pyramidal cores of physeal cartilage projecting into the metaphysis. Often, these two lesions occur simultaneously in the same bone. The disease occurs during maximal growth when the biomechanical stresses are greatest in the immature skeleton (4-8 months in dogs). It is most common in large and giant breeds of dogs and in rapidly growing pigs, horses (Osteochondrosis), turkeys, and chickens.

Other degenerative joint diseases are degenerative arthritis and arthropathy.

Degenerative arthritis, a progressive deterioration of articular cartilage in diarthrodial joints, is characterized by hyaline cartilage thinning, joint effusion, and periarticular osteophyte formation. Joint degeneration can be caused by trauma, infection, immune-mediated diseases, or developmental malformations. The inciting cause initiates chondrocyte necrosis, release of degradative enzymes, synovitis, and continued cartilage destruction and inflammation. Abnormal cartilage congruency and joint capsule anatomy can further lead to alteration in normal joint biomechanical function. Pain and lameness develop secondary to joint dysfunction or muscle atrophy and to limb disuse. Clinical signs of degenerative joint disease include lameness, joint swelling, muscle atrophy, pericapsular fibrosis, and crepitation. Radiographic changes in the joint include joint effusion, periarticular soft-tissue swelling, osteophytosis, subchondral bone sclerosis, and possibly narrowed joint. Arthrocentesis may be unremarkable or yield minor changes in color, turbidity, or cell counts of synovial fluid. Treatments can be medical or surgical. Nonsurgical therapies include weight reduction, controlled exercise on soft surfaces, and therapeutic application of warm compresses to affected joints. Nonsteroidal anti-inflammatory drugs (eg, aspirin, phenylbutazone, or carprofen) will reduce pain and inflammation. Corticosteroids will also suppress prostaglandin synthesis and subsequent inflammation, but short-term use is advised to prevent iatrogenic Cushing's syndrome, cartilage degeneration, and intestinal perforation. Joint fluid modifiers such as glycosaminoglycans or sodium hyaluronate prevent cartilage degradation, although results of objective clinical trials are not available. Surgical options include joint fusion (arthrodesis), most frequently performed on the carpus and tarsus; joint replacement, such as total hip replacement; joint excision, such as femoral head and neck osteotomy; and amputation. Prognosis is variable and depends on the location and severity of the arthropathy.

Arthropathy: This nonspecific condition affecting mainly the hip and stifle is characterized by degeneration of articular cartilage and eburnation of subchondral bone, joint effusion, fibrosis with calcification of the joint capsule, and osteophytes. Many causes and predisposing factors probably influence the development, age of onset, and severity. Inherited predisposition to degenerative arthropathy occurs. Joint instability after trauma is a common cause. Nutritional factors involved in some cases are rations high in phosphorus and low in calcium, which probably influence the strength of subchondral bone. Copper deficiency or fluoride poisoning also may act similarly. The role of infection is unclear. Onset is gradual, and both hip joints are usually affected; stifle involvement is rare. Signs progress concomitantly with degeneration of cartilage and development of osteophytes. Lameness to the point of incapacitation, with crepitation of degenerate joints, may develop in a few months; however, correlation between pathologic changes and clinical signs is poor. The earliest changes occur in the acetabulum and on the dorsomedial surface of the femoral head. Changes in the joints are usually irreversible by the time the diagnosis is made. Palliative treatment in valuable breeding animals should be undertaken with the knowledge that the condition or predisposing factors may be inherited. The diet should be carefully analyzed and, if necessary, corrected. This is especially important in fast-growing animals, in which adequate exercise is indicated and overfinishing should be avoided.

An animal model for demonstrating the efficacy of the food and method of treatment in accordance with the invention is, e.g., a giant breed puppy such. as a great dane. 32 puppies (4 months of age) are assigned randomly to be supplemented daily with about 1000 IU/kg dog food of vitamin D₃, about 1000 IU/kg dog food of 25-hydroxycholecalciferol, about 500 IU/kg dog food of vitamin D₃ plus about 500 IU/kg dog food of 25-hydroxycholecalciferol, about 1000 IU/kg dog food of vitamin D₃ plus about 1000 IU/kg dog food of 25-hydroxycholecalciferol and and about 2000 IU/kg dog food of vitamin D₃ plus about 2000 IU/kg dog food of 25-hydroxycholecalciferol for 6 months.

The following parameters for the determination of changes in dog's joint health, e.g., the presence of osteochondrosis and progress in the treatment of the disease are measured: General health status, bone mineral density by QCT, X-Ray, biochemical markers of bone turnover (Total Alkaline Phosphatase in serum; bone specific Alkaline Phosphatase in serum (bone formation); pyridinoline and deoxypyridinolin in urine (bone resorption); osteocalcin (bone formation)), creatinin, metabolites of Vitamin D₃ (1,25 (OH)₂-; 24,25(OH)₂-, 1,24,25(OH)₃-, 25(OH)-Vitamin D₃) in plasma, GH, IGF-I, parathyroid hormone, calcitonin, plasma calcium and phosphate, calcium balance, histology of epiphysis cartilage (rip) for determination of endochondral ossification, as well as radiology, histomorphometry, and autoradiogram.

The desired dosage of 25-hydroxycholecalciferol and, optionally, vitamin D₃ can be administered by any conventional means, e.g., as a veterinary formulation for enteral or parenteral application or, preferably, as a feed supplement. When both 25-hydroxychole calciferol and vitamin D₃ are administered such administration may be simultaneous or sequential. While the ratio of 25-hydroxycholecalciferol: vitamin D₃ if administered in combination, is not narrowly critical, said ratio may range from about 1:9 to about 9:1 with a ratio of 1:1 being preferred.

For treatment and prevention of joint diseases in pets, especially dogs, an appropriate daily dosage for a dog would be from about 5-20 IU of 25-hydroxycholecalciferol and, optionally, 5-20 IU of vitamin D₃. 25-hydroxycholecalciferol and, optionally, vitamin D₃ are suitably administered as a food supplement in an amount to provide a concentration of about 500 to about 5000 IU of 25-hydroxycholecalciferol and, if desired, from about 500 to about 5000 IU of vitamin D₃ per kg food, the total amount of 25-hydroxycholecalciferol and vitamin D₃ not exceeding 5000 IU per kg food. The term “food” when used in context with concentrations of 25-hydroxycholecalciferol and vitamin D₃, respectively, contained in said food refers to food which provides a metabolizable energy of about 4000 kcal or about 17 Mjoule per kg food.

The pet food according to the present invention may be based on any conventional pet food. Particulars as to the composition of pet food can be seen, e.g., from WO 03/047363. There is a wide range of pet foods available which may be grouped into (a) complete diets, (b) complementary diets, and (c) snacks and treats. Complete diets may be fed in addition to water for an extended period as the sole source of nutrients and will provide for all the energetic and nutrient needs of the animal and the physiological state for which it is intended. Complementary diets normally are not sufficient to ensure that all nutrient and energy requirements are met unless fed in combination with another foodstuff or diet. Snacks and treats are appetizers or for occasional feeding and are considered as complementary products. There are, however, a number of products available intended to form part of the daily diet or playing a role in animal well-being, e.g dental chews. In the present invention dental chews are especially suitable.

25-Hydroxycholecalciferol and vitamin D₃ (hereinafter: Inventive Ingredients) may be incorporated into conventional pet food e.g., into dry pet food by spraying an aqueous solution containing one or more Inventive Ingredients on the food composition while thoroughly mixing the composition, or by adding one or more Inventive Ingredients to the dough. Inventive Ingredients may be added simultaneously, e.g. at the same time and even as a premix, or consecutively as single Inventive Ingredient at a time or as a premix. Premixes may also include one or more of the other components of the final composition.

The following examples illustrate the invention further.

### EXAMPLE 1

Commercial dry dog food (Royal Canin “Maxi Junior” for dogs as supplied by Royal Canin GmbH, Postfach 510954, D-50945 Köln) is sprayed with an aqueous solution or dispersion of 25-hydroxycholecalciferol (e.g., Hy•D® 1.25% as supplied by Roche Vitamins) and vitamin D₃ in an amount sufficient to provide 800 IU/kg of 25-hydroxycholecalciferol and 800 IU/kg of vitamin D₃ in the final food composition.

### EXAMPLE 2

Commercial dry dog food (Royal Canin “Maxi Junior” for dogs as supplied by Royal Canin GmbH, Postfach 510954, D-50945 Köln) is mixed with an aqueous solution or dispersion of 25-hydroxycholecalciferol (e.g., Hy•D® 1.25%) and vitamin D₃ in an amount sufficient to provide about 500 to about 2000 IU/kg dog food of 25-Hydroxycholecalciferol, 500 to about 2000 IU/kg dog food of vitamin D₃ in the final food composition before cooking the entire blend. The food composition is dried to contain a dry matter of about 90% by weight.

### EXAMPLE 3

Commercial dog treats (Mera Dog “Biscuit” for dogs as supplied by Mera Tiernahrung GmbH, Marienstrasse 80-84, 47625 Kevelaer-Wetten, Germany) are sprayed an aqueous solution or dispersion of 25-hydroxycholecalciferol (e.g., Hy•D® 1.25%) and vitamin D₃ in an amount sufficient to 500 to about 2000 IU/kg dog food of 25-Hydroxycholecalciferol and 500 to about 2000 IU/kg dog food of vitamin D₃.

### EXAMPLE 4

Commercial dry cat food (Hill's Science diet “Feline Maintenance dry” for cats as supplied by Hill's Pet Nutrition GmbH, Liebigstrasse 2-20, D-22113) is sprayed with an aqueous solution or dispersion of 25-hydroxycholecalciferol (e.g.,Hy•D® 1.25%) and vitamin D₃ in an amount sufficient to provide 500 to about 2000 IU/kg dog food of 25-Hydroxycholecalciferol and 500 to about 2000 IU/kg dog food of vitamin D₃. The food composition is dried to contain a dry matter of about 90% by weight.

### EXAMPLE 5

Commercial wet cat food (Hill's Science diet “Feline Maintenance wet” for cats as supplied by Hill's Pet Nutrition GmbH, Liebigstrasse 2-20, D-22113) is sprayed with an aqueous solution or dispersion of 25-hydroxycholecalciferol (e.g.,Hy•D® 1.25%) and vitamin D₃ in an amount sufficient to provide 500 to about 2000 IU/kg dog food of 25-hydroxy-vitaminD₃ and 500 to about 2000 IU/kg dog food of vitamin D₃ in the final food composition before cooking the entire blend. The food composition is dried to contain a dry matter of about 90% by weight.

### EXAMPLE 6

Commercial cat treats (Whiskas Dentabits for cats as supplied by Whiskas, Masterfoods GmbH, Eitzer Str. 215, 27283 Verden/Aller, Germany) are sprayed with an aqueous solution or dispersion of 25-hydroxycholecalciferol (e.g., Hy•D 1.25%) and vitamin D₃ in an amount sufficient to provide 500 to about 2000 IU/kg dog food of 25-hydroxy-vitaminD₃ and 500 to about 2000 IU/kg dog food of vitamin D₃ in the final food composition before extruding the entire dye. The food composition is dried to contain a dry matter of about 90% by weight.

1. A pet food comprising from about 500 to about 5000 IU/kg of 25-hydroxycholecalci-ferol.

2. A pet food as in claim 1 comprising, additionally, from about 500 to about 5000 IU/kg of vitamin D₃, the total amount of 25-hydroxycholecalciferol and vitamin D₃ not exceeding 5000 IU per kg food.

3. A food as in claim 1 which is a dog food.

4. A food as in claim 3 which is a food for large or giant breed dogs.

5. A composition as in claim 1 for the treatment or prevention of osteochondrosis, degenerative arthritis or arthropathy in pets, particularly large or giant breed dogs.

6. The use of of 25-hydroxycholecalciferol in the manufacture of a food or veterinary composition for treatment or prevention of joint diseases in pets, particularly large or giant breed dogs.

7. The use as in claim 6 wherein 25-hydroxycholecalciferol is used in combination with vitamin D₃.

8. The use as in claim 6 wherein the joint disease is osteochondrosis, degenerative arthritis or arthropathy.

9. The use as in claim 6 in the manufacture of a dog food.

10. The use as in claim 9 wherein the dog food contains from about 500 to about 5000 IU/kg of 25-hydroxycholecalciferol.

11. The use as in claim 9 wherein the dog food contains from about 500 to about 5000 IU/kg of 25-hydroxycholecalciferol and from about 500 to about 5000 IU/kg of vitamin D₃, the total amount of 25-hydroxycholecalciferol and vitamin D₃ not exceeding 5000 IU per kg food.

12. A method of treatment or prevention of osteochondrosis in pets which comprises administering to a pet in need of such treatment or prevention an effective amount of 25-hydroxycholecalciferol.

13. A method of treatment or prevention of osteochondrosis in pets which comprises administering to a pet in need of such treatment or prevention an effective amount of 25-hydroxycholecalciferol and vitamin D₃.

14. A method as in claim 12 wherein the pet is a large or giant breed dog.

15. A method as in claim 12 wherein from about 5 to about 20 IU of 25-hydroxycholecalciferol per kg body weight per day are administered.

16. A method as in claim 12 wherein from about 5 to about 20 IU of 25-hydroxycholecalciferol per kg body weight per day and from about 5 to about 20 IU/kg of vitamin D₃ per kg body weight per day are administered.
